(19) United States
(12) Patent Application Publication
(10) Pub. No.: US 2017/0350800 A1
(43) Pub. Date: Dec. 7, 2017

(54) METHOD FOR DETERMINING PARTICLES

(71) Applicant: Grundfos Holding A/S, Bjerringbro (DK)

(72) Inventors: Mathis DAHLQVIST, Vejle Ø (DK); Christian SMITH, Niendorf / Ostsee (DE); Bo HØJRIS, Odder (DK)

(21) Appl. No.: 15/540,675

(22) PCT Filed: Dec. 9, 2015
(86) PCT No.: PCT/EP2015/079153

§ 371 Date: Jun. 29, 2017

(30) Foreign Application Priority Data
Dec. 30, 2014 (EP) 14200634.5

(51) Int. Cl. G01N 15/02; G01N 15/14; G06N 3/04; G01N 21/49; G01N 21/88

(52) U.S. Cl. CPC G01N 15/0211; G01N 21/49; G01N 21/8806; G06N 3/0463; G01N 15/1434; G01N 2015/0222; G01N 2015/0294; G01N 2015/1445; G01N 2021/8822; G01N 2015/0238

(57) ABSTRACT

A method serves for determining particles (3), in particular bacteria in fluid and operates using an imaging optical device with a light source (1), with an optical sensor (4) with a field of light-sensitive pixels and with a fluid sample, which is to be examined, arranged between the light source (1) and the sensor (4). Characteristics of at least one particle (3), which is detected with regard to imaging, are compared to characteristics of a characteristics collection for determining the detected particle (3). The image acquisition is effected with darkfield technology and a light-sensitive pixel comprises several subpixels which are used for image acquisition.

### CROSS REFERENCE TO RELATED APPLICATIONS

This application is a United States National Phase Application of International Application PCT/EP2015/079153, filed Dec. 9, 2015, and claims the benefit of priority under 35 U.S.C. §119 of European Application 14200634.5, filed Dec. 30, 2014, the entire contents of which are incorporated herein by reference.

### FIELD OF THE INVENTION

The invention relates to a method for determining particles in a fluid, in particular of bacteria in water using an imaging optical device with a light source, with an optical sensor with a field of light-sensitive pixels and with a fluid sample which is to be examined, arranged between the light source and the sensor.

### BACKGROUND OF THE INVENTION

Such methods for the optical detection of particles in a fluid, in particular for determining or at least for classifying particles, are counted as belonging to the state of the art. In this context, EP 2 469 264 A1, WO 2010/063293 A1 and WO 2014/094790 A1, are referred to. There, methods are described, with which the detection of particles in fluid is effected by way of an optical device which comprises a light source and an optical sensor with a field of light-sensitive pixels, wherein a fluid sample which is to be examined is arranged between the light source and the sensor and with which characteristics of at least one particle detected with regard to imaging is used, in particular compared with characteristics of a characteristic collection for determining or at least classifying the detected particle, for determining the particle. The optical detection of the fluid sample is thereby preferably effected in a quasi stationary condition, thus when the particles within the fluid have calmed to such an extent that they have either sunk due to gravity, floated to the top or are located in a stationary suspended condition, thus their position between the light source and the sensor essentially does not change. This method is well suitable for determining larger particles, for example suspended particles, fine sand or likewise, as are occasionally entrained by water. However, this method reaches its limits, in particular with the examination of drinking water, with which it is the case of determining the type and number of bacteria, for example E. coli bacteria (Escherichia coli), since these small particles are often difficult or not even possible to be identified in the image.

### SUMMARY OF THE INVENTION

It is therefore an object of the present invention, to improve a method of the known type, to the extent that in particular small particles, of the size magnitude of bacteria, can be reliably determined with as low as possible technical effort. Thereby, the preferred application is to be for determining bacteria in drinking water.

The method according to the invention serves for determining particles or at least for classifying, in a fluid, in particular bacteria in drinking water, for example with the regular testing of drinking water with regard to germs, and is carried out using an imaging optical device which comprises a light source and an optical sensor with a field of light-sensitive pixels. The fluid sample to be examined is arranged between the light source and the sensor. With the method, characteristics of at least one particle which are detected in an imaging manner with the optical device are used with characteristics of a characteristic collection, for determining or classifying the detected particle. The characteristics in particular are compared, in order to determine the detected particles, in particular to determine whether hereby it is the case of a bacteria or non bacteria, or moreover to determine the bacteria. According to the invention, one envisages the image acquisition on the one hand being effected with darkfield technology, i.e. under darkfield illumination, and on the other hand light-sensitive pixels of the sensor comprising several subpixels which are used for the image acquisition, in order in particular to detect these small particles with technically simple means and with a sufficient accuracy. It is to be understood that advantageously all or at least a large part of the light-sensitive pixels comprises subpixels which are used for image acquisition, in order on the one hand to ensure a high resolution and on the other hand to obtain high dynamics. This is particularly advantageous with darkfield technology, with which a darkfield illumination is effected, i.e. with which the fluid sample to be examined does not lie in the direct beam path between the light source and the sensor, as is common with brightfield technology, but only light, specifically scattered light which is deflected by the particles in the fluid sample is received by the sensor. The image acquisition with darkfield technology thus according to the invention is effected in a manner as is known from darkfield illumination in transmitted light microscopy. Hereby, the particles appear in a bright color against a dark background on the sensor image. This is particularly advantageous with the very small particles which are to be determined here, since the glaring known from brightfield technology occurs essentially less often and otherwise the sensor is also not subjected to direct light of the light source, which is why, in particular in combination with the use of subpixels, a significantly better detection of small particles, such as bacteria for example is possible, without the technical preconditions such as the resolution of the sensor, the quality of the applied optical components and likewise having to be significantly increased.

Thereby, according to a further development of the method according to the invention, it is particularly advantageous if the image acquisition is effected by way of two-dimensional black-and-white images in different planes of the fluid sample. In contrast, since it is not the question of the color information, the subpixels of the sensor which are otherwise available for this, can be used to increase the resolution of the sensor or its dynamics, as can advantageously be envisaged according to a further development of the invention.

Thus, the dynamics of the image acquisition according to a further development of the invention is e.g. increased by way of at least one pixel of the sensor, preferably however a large part or all pixels comprising such subpixels, and of these subpixels in each case at least one being high gained and at least one further one being low gained. Low gained in the context of the present invention can also be understood as attenuation, depending on the sensitivity region the sensor is to have. With CCD-sensors which are widely used nowadays, whose pixels e.g. comprise four subpixels, according to the present invention advantageously two of these subpixels are high gained and the other two are low gained or attenuated. The number of subpixels however is basically freely selectable or dependent on the sensor, and is selected according to the demands of the method.

The determining of at least one particle by way of two-dimensional black-and-white images for example, in different planes of the fluid sample, is advantageously effected by way of digital image evaluation. Such evaluation methods are basically counted as belonging to the state of the art, but however need to be suitably adapted for the present method.

Thereby, it is advantageous if at least three, preferably at least four different characteristics are used for determining or classifying a particle. Thereby, the determining of the particle in the context of the present invention does not necessarily need to mean the specific identification of the particle, but a classification, such as ascertaining as to whether with regard to the particle it is the case of a bacterium or of non bacterium, whether it is the case of a living or dead bacterium, of which type of bacterium it is a case of, or likewise, can also be effected.

A characteristic of a particle which can be particularly well detected is its extension with regard to area, which according to the invention is determined in an image and used further, in which image the particle is in focus. Thereby, not only does the detection of the area with regard to size provide a characteristic, but the shape of the area can also form a characteristic, or a combination of these features.

According to an advantageous further development of the method according to the invention, one envisages fixing a pixel limit value in the image of the particle which is detected by way of the sensor, for detecting the extension of a particle with regard to area, wherein all pixels whose pixel value is greater or equal to the fixed pixel value are set to 1 and all pixels whose pixel value is smaller than the set pixel value are set to 0, whereupon the extension of the particle with regard to area is detected. Thus, a digitalization of the image into black and white pixels is effected, wherein then for example the white pixels, thus those whose pixel value is greater or equal to the fixed pixel limit value, represent the area of the particle in the image, so that the extension with regard to area as well as the shape of the area can be determined by way of a suitable evaluation of this black-and-white image.

Thereby, it has been found in practical trials of the method that here it is advantageous not to set an absolute pixel limit value, but to determine the extension of the particle with regard to area advantageously on the basis of several differently fixed pixel limit values. Only by way of this is it possible with some particles, to determine their shape and to create an adequate differentiation from other particles. It is particularly advantageous if the pixel limit values are set automatically, i.e. in a self-adapting manner.

Advantageously, the rotation of a particle about its own axis is determined as a characteristic of a particle. This characteristic is particularly useful on determining bacteria. It is often already possible with this characteristic to differentiate bacteria from non bacteria or dead bacteria, since the rotation of a particle about its own axis is a typical feature of living bacteria, but also of a few other particles. The rotation can moreover itself also be used as a further characteristic on determining the particle, in particle of a bacterium.

According to the method according to the invention, a characteristics of a particle can be effected by way of evaluating a series of images of particles in different planes, which are selected such that the particles are in focus in some images and are out of focus in some images, thus lie in front of or behind it, wherein the number of the pixel values representing the particle is detected in an image-wise manner and the distribution of the detected numbers over the number of images forms the characteristic. This is a way of determining as to whether the particle, such as a living bacterium moves or for example like a grain of dust remains unchanged in its position in the fluid. Thereby, advantageously not only the distribution of detected particles over the number of images acquired, but according to a further development of the method according to the invention, the standard deviation of the detected numbers is set in relation to the mean of the detected umbers, in order to thus form a characteristic.

As initially explained, advantageous not only is the extension of a particle with regard to area and which is in focus detected, but moreover also its shape, in order to form a characteristic. The shape of a particle can be determined by its moments. This is counted as belonging to the state of the art with image evaluation methods. Moments of a distribution in image processing are certain weighted means from the brightness values of the individual pixels of an image. They are selected such that they provide certain geometric information, as is counted as belonging to the state of the art with digital image processing, which is referred to inasmuch as this concerns.

Alternatively or additionally, the shape of a particle can be determined by its inverse moments. According to a further development of the method according to the invention, an evaluation of a series of images of the particle can be effected in different planes for detecting the inverse moments of the particle, wherein the particle in at least one image lies in the focus and in a number of images lies in front of it or therebehind. Thereby, the pixel values of the image are subjected to a Fourier transformation, whereupon the DC components, thus the non-frequency components of the signal are removed or at least reduced, the noise component of the signals eliminated and an evaluation of the moments then made, as is counted as belonging to the state of the art. A characteristic which in practice has been found to provide valuable information is obtained by way of this.

According to a further development of the invention, one envisages keeping the illumination intensity of the light source constant, and to provide a closed-loop control for this, which detects the actual illumination intensity, compares it with a desired illumination intensity and, as the case may be, accordingly activates the light source, in order to ensure that comparable results are also achieved over a longer period of time, in particular with the examination over a longer time period, as is the case e.g. when monitoring drinking water. This is of particular significance with the method according to the invention, since the image sensor on account of the darkfield illumination never detects direct light from the light source and thus for example a reduction of the background brightness is not necessarily due to a reducing illumination intensity of the light source, but can also be due to the growth of deposits in the window for the fluid sample. It is therefore advantageous to provide a separate sensor, with which the actual illumination intensity of the light source can be detected so that, given an attenuating light intensity, this for example can be compensated by activation with a higher voltage, by way of the closed-loop control.

The classification or determining of a particle detected by way of the optical device is typically effected by way of comparison of characteristics of this particle with characteristics of a characteristics collection, by way of which a categorization, classification or in the ideal case a specific determining of the particle can be effected. The determining is advantageously effected with a non-linear system, preferably by way of a neuronal network, and as a rule a result can also be achieved by way of this, if the determined characteristics do not permit a direct deduction of the type of particle. The use of a neuronal network is particularly advantageous if, as has been found in practice, not only images in focus are evaluated, but also images which are directly in front of or behind this, since the reliability of the classification or the determining can be increased with this, even if the characteristics determined with this have a certain blurring.

Alternatively, the determining of a particle can be effected by way of comparing detected characteristics with characteristics of the characteristics collection by way of a linear system. Both methods have their advantages and disadvantages, wherein in the individual case one should carefully consider in which way the evaluation is effected.

On the one hand, it is necessary to keep the effort with regard to the device as simple as possible and on the other hand to keep the computation effort as small as possible, in order to be able to carry out the method according to the invention in an inexpensive manner.

However, the method according to the invention should have the necessary accuracy, in order to be able to differentiate at least between bacteria and non bacteria with a high reliability. For this, according to a further development of the invention, one envisages the lens arranged in front of the sensor and being necessary in order to produce an image on the pixel plane of the sensor, having a numeric aperture between 0.05 and 0.4. Such a numeric aperture on the one hand has the advantage that lenses of a simple quality and which are inexpensive can be used, but on the other hand the number of images which are to be evaluated does not become too large, as would be the case with an increasing aperture.

According to the invention, one envisages images of the same fluid sample being evaluated under illumination with a different illumination angle, in order to provide further differentiation possibilities on detecting the particles. The previously described characteristics for example can be further differentiated by way of this. Also, as the case may be, one can additionally or alternatively operate with illumination of a different wavelength on creating these images. This represents a further differentiation possibility of characteristics which in particular can be advantageous for small particles having the size magnitude of bacteria.

A specific determining of the particles does not necessarily need to be effected with the method according to the invention, however usefully a classification of the particles is effected, and specifically into bacteria, non bacteria and other particles. Such a classification in particular is useful when monitoring drinking water.

Thereby, in particular when monitoring drinking water, it can be necessary for not only the number of bacteria in the water to be detected, but also the type. Thus, for example, E. coli bacteria can be an indication of feces, thus a feces indicator. Firstly, for the detection of feces, a classification of the determined particles into bacteria and non bacteria can be effected once for example in the method according to the invention, whereupon the killing of germs for example by way of UV light, heat or likewise is initiated in the fluid sample. A determining of particles of the same sample is carried out once again after a certain period of waiting, for example half an hour, and thereby for example one determines as to how the ratio of living to dead bacteria sets in after the germ elimination, for example by way of determining the rotation of the particles. The share of E. coli bacteria can e.g. be indirectly deduced by way of this.

The method according to the invention is basically applied on the basis of a characteristics collection. Such a characteristics collection however does not need to be present in a complete manner. As the case may be, this can be produced or supplemented on starting operation of the device. Thus, firstly, only water, with regard to which it is known that it comprises a permissible particle contamination, can be examined for example in the first days after starting operation of the examination device. A characteristics collection can be made with the characteristics regarding the particles detected in the water and obtained with these examinations, and this characteristics collection in turn is the basis for further examinations, with which however it is not the determining of the particles which is at the forefront, but the agreement or non-agreement of the particle structure with the previously determined ones, said structure forming the basis for the characteristics collection.

The present invention is described in detail below with reference to the attached figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a greatly simplified schematic representation of an optical device for examining a fluid sample in darkfield technology;

FIG. 2 is a simplified schematic representation of an optical device, according to the state of the art, in brightfield technology;

FIG. 3 is a view showing a construction of an optical sensor of the optical device;

FIG. 4 is an image and signal representation of the evaluation of the sensor signal amid the inclusion of the subpixels;

FIG. 5 is a view of a series of images which shows the same particles in different planes;

FIG. 6 is a view of eleven consecutive images of the same particle in different planes;

FIG. 7a is one of three digitalized particle representations of the same particles amid the application of different limit values, with a grey scale representation for comparison;

FIG. 7b is another of three digitalized particle representations of the same particles amid the application of different limit values, with a grey scale representation for comparison;

FIG. 7c is another of three digitalized particle representations of the same particles amid the application of different limit values, with a grey scale representation for comparison;

FIG. 8 is a view of two curves which enclose and determine the areas represented by the particle representations according to FIGS. 7b and 7c;

FIG. 9 is a view of twenty five images of a particle in consecutive planes, in and out of focus;

FIG. 10 is a view of the formation of frequency distribution curves on account of the images according to FIG. 9;

FIG. 11 is a view of the means curve which is formed from the curves according to

FIG. 10, with deviations for forming a characteristic;

FIG. 12a is a view of one of three images in the context of the evaluation of the moment of inertia as a characteristic;

FIG. 12b is a view of another of three images in the context of the evaluation of the moment of inertia as a characteristic;

FIG. 12c is a view of another of three images in the context of the evaluation of the moment of inertia as a characteristic; and

FIG. 13 is an amplitude-frequency diagram of a Fourier-transformed image without DC component.

### DESCRIPTION OF THE PREFERRED EMBODIMENTS

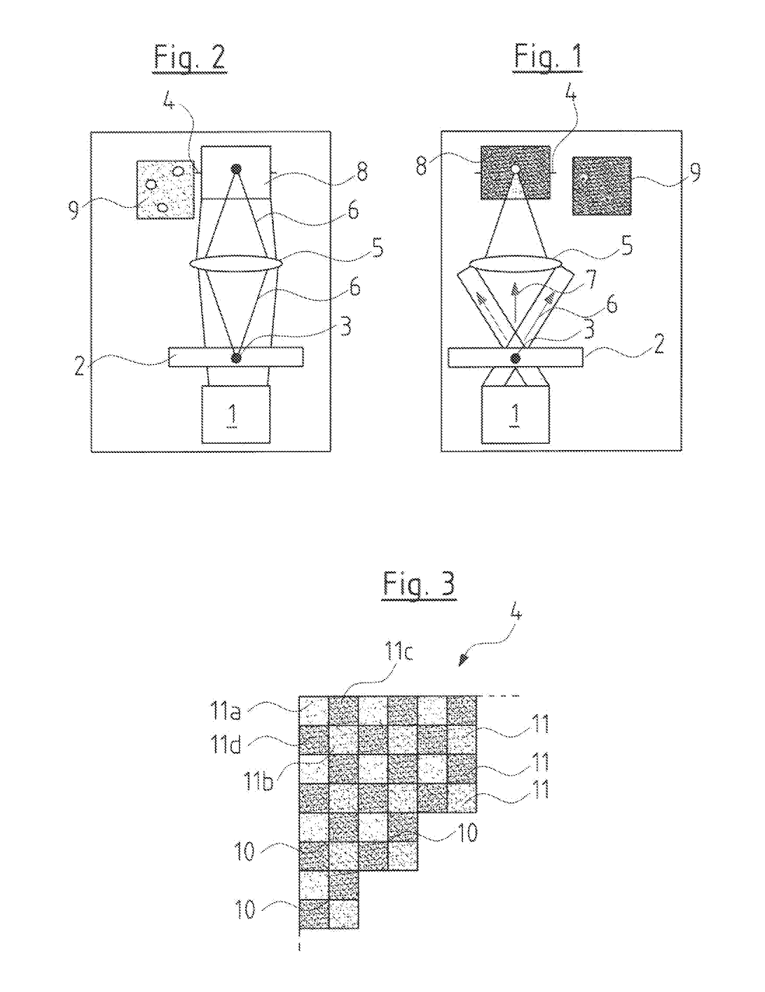

As to how darkfield technology, as is applied with the optical device according to the invention and according to FIG. 1, differs from classic brightfield technology as is represented in FIG. 2, is represented by way of these FIGS. 1 and 2. A light source 1 which beams a fluid sample arranged in a window 2, for illustration only with one particle 3 located therein, is shown in both figures. The fluid sample located in the window 2 is arranged between the optical light source 1 and a CCD sensor 4, in front of which a focusing lens 5 is arranged, which here symbolizes imaging optics. The light source 1 in FIG. 1 is aligned by way of an aperture for example, such that direct beams 6 illuminate the window 2 with the particle 3, but neither directly hit the lens 5 nor the CCD sensor 4 lying therebehind. Only scattered light 7 gets from the particle 3 to the focusing lens 5 and the CCD sensor 4 lying therebehind. An image 8, with which the particle 3 is represented in a white manner against a dark background results from this. The Picture 9 which is represented next to this illustrates how an image of two particles can practically look given this illumination.

In comparison to this, the light source 1 is directed directly onto the window 2 and the particle 3 located in the fluid as well as the lens 5 and the sensor 4, in FIG. 2. The particle 3 which shadows the direct light 6 is produced by way of the lens 5 as a black dot in the Picture 8, thus on the CCD sensor 4. In the corresponding Picture 9 arranged next to this, one can see three particles whose black edges are distinguished against a grey background.

In particular small particles can be represented significantly better in the 2D Picture 8, 9 with the darkfield illumination as is represented in FIG. 1 by way of example, than is possible with brightfield illumination as is represented by way of FIG. 2. There, the edge of the particle 3 in Picture 8 is greatly glared. The contrast between the represented particle and the background is extremely high and the resolution within the imaged particle is thus poor, since the direct beams 6 hit the CCD sensor 4. One can clearly recognized with the Picture 9 of FIG. 1 as to which nuanced graduations are already visible with the naked eye against the black background. The darkfield illumination as is represented in FIG. 1 is only to be understood by way of example. Thus, for example, separate light sources can be provided instead of a central light source 1 and these obliquely shine through the window similarly as is shown in FIG. 1. What is essential however is the fact that only scattered light gets from the particle 3 to the lens 5 and the sensor 4 lying therebehind, and no direct radiation gets from the light source to the sensor.

FIG. 3 shows the structure of a CCD sensor 4 as is commercially widespread today. Each pixel 10 of the sensor 4 consists of four subpixels 11 and specifically of a blue subpixel 11a, a red subpixel 11b and two green subpixels 11c and 11d. The colors, apart from providing each pixel 10 with brightness information, also serve for providing them the color information which is necessary in order to produce a color image.

With the method according to the invention, 2-D images are produced in black and white, i.e. with grey scales and the color information is not necessary. The subpixels 11 are therefore applied for increasing the resolution and dynamics.

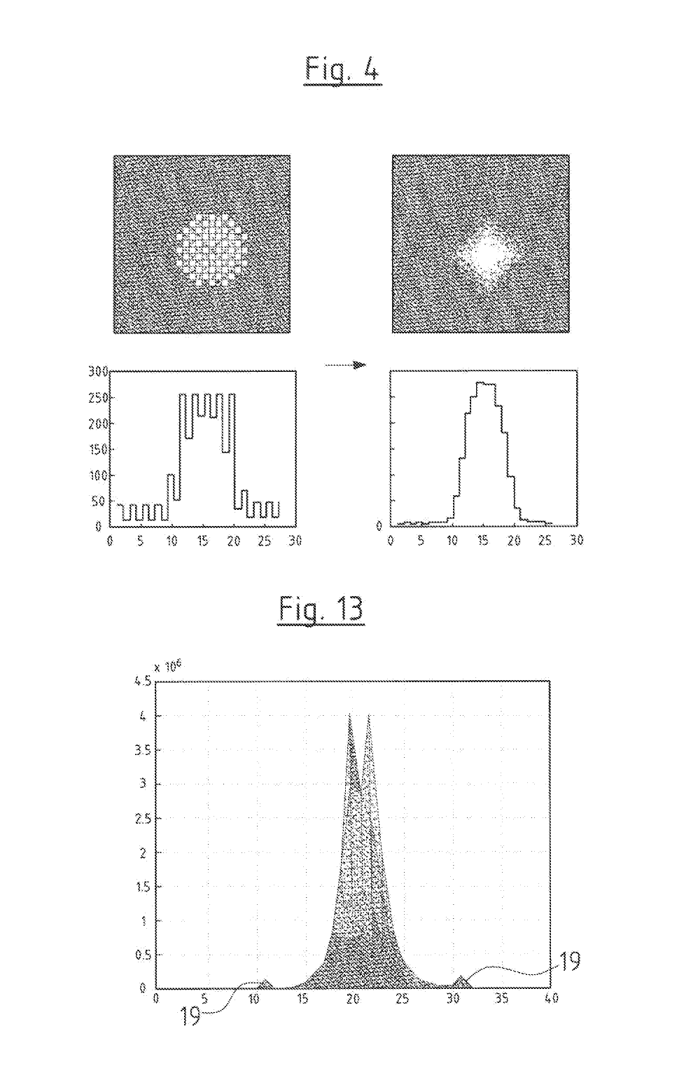

With regard to the CCD sensor 4 represented in FIG. 3, it is the case of a Bayer sensor with a Bayer matrix. Instead of evaluating the subpixels for retaining the color information as is common, these here on the one hand are used for increasing the resolution, as the respective left upper image of FIG. 4 shows. Moreover, the subpixels 11 or their signals are differently processed. Thus, the subpixels 11a and 11b are low gained, whereas the subpixels 11c and 11d are high gained. A higher dynamics region results by way of this, which is likewise evident by way of FIG. 4 in the left, lower image. As is shown by the left upper image which is produced according to the method described above, the image produced with the above-described method not only has a higher resolution but also higher dynamics, as in particular the grey scales recognizable there illustrate. The resolution is increased by a factor of four and the dynamics are likewise considerably increased. The increased resolution is achieved by way of the use of the subpixels 11 as pixels and the higher dynamics due to the fact that the subpixels each in pairs are low gained or high gained, as is evident in the left upper picture as well as in the signal curve which is located below this. The image which is shown on the right in FIG. 4 and which has a greater resolution and higher dynamics than an image created with a conventional read-out of the CCD sensor then arises by way of interpolating the low gained subpixels with the high-gained subpixels. Even if this improved image information cannot be recognized without further ado on the image or signal representation at the right in FIG. 4, one should take into account the fact that the grey scales which are visible there have a different quality than if these were to be effected with the common evaluation of the CCD sensor signal.

In order to determine or at least classify a particle detected with the CCD sensor 4, it is necessary to determine various characteristics of the particle and then to compare these with an existing characteristics collection, in order to ascertain as to which types of particles or in the ideal case as to which particle it is a case of. Thereby, the characteristics collection or libraries can be created individually, for example for drinking water, service water, waste water, water from sewage plants or also for other fluids with particles located therein. Thereby, the characteristics collection is to be directed to the demands of the user. Thus, for example, it is essential for drinking water analysis to recognize whether it is the case of bacteria or non bacteria, and moreover of which bacteria. The aim can be to determine or detect E-coli bacteria for example, in order to monitor the water quality. Such characteristics collections as the case may be can be created on location in a self-learning manner if particles which with regard to their shape and their number have been ascertained as being allowable and acceptable, are determined in a number of prior examinations. Thereby, deviations from the previously detected quality can be ascertained with such an automatically created characteristics collection. It is to be understood that a characteristics collection for monitoring drinking water for example can also vary depending on location, thus can be different at different locations, since the bacteria types which could contaminate the water vary depending on the location and the climate. The more characteristics of a particles detected by image correspond to a characteristic in the characteristics collection, the more accurate is the detection. Just a few can be used for the comparison or also a few hundred or even more. The evaluation is effected for example via a neuronal network but can also be effected by way of a linear equation system. However, it has been found that with regard to the question as to whether it is a case of bacteria or non bacteria, a comparison of at least three characteristics, advantageously at least four characteristics is sufficient, in order to determine this with a sufficient reliability. The number of characteristics can be significantly high in special cases.

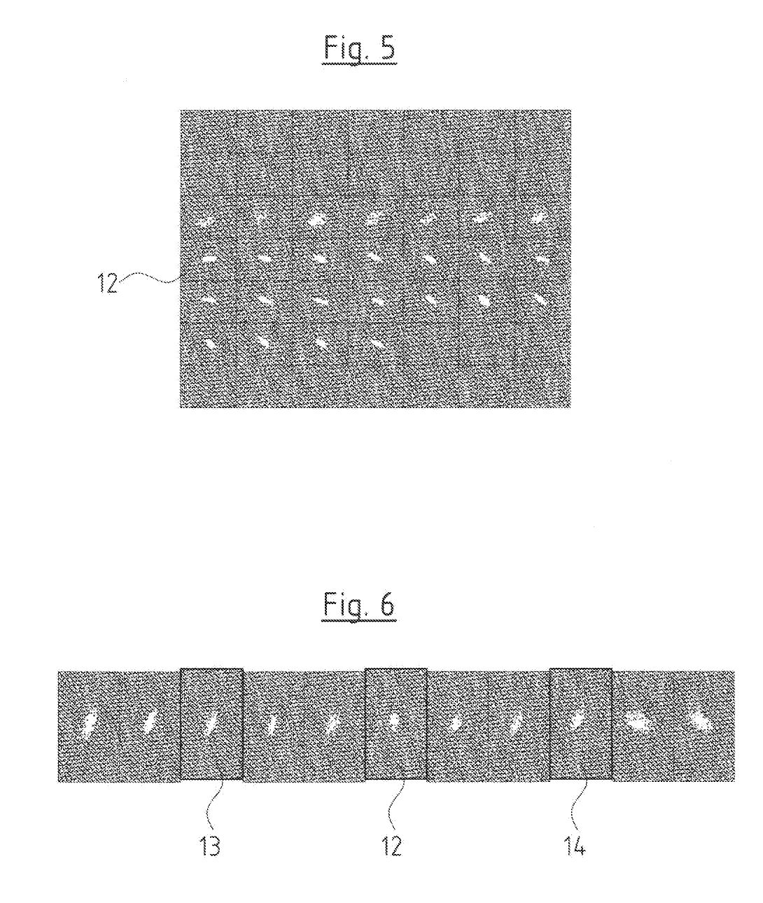

The detection of a fluid sample with the quasi stationary particles which are located therein is effected by way of a multitude of images of parallel planes. Thus, for each particle detected by imaging, groups of images of the same particle which represent this particle in different planes are created, with the image evaluation after a first object examination, which e.g. excludes oversized objects such as air bubbles and likewise as well as clearly non-evaluatable regions from the further evaluation (integrity examination). Since a contour-focused representation is only possible in the focus plane due to the aperture of the imaging lens 5 of the optical device, these particles in the groups of images typically appear in several (blurred) pre-focus positions, in one or more focus positions and in several (blurred) post-focus positions. Such images of a particle are represented for example in FIG. 5 which shows 39 images of the same particle in focus and out of focus. With regard to these images one empirically detects as to in which image or images the particle 3 is represented in focus. This image with the particle 3 in focus is indicated at 12 in FIG. 5. The computation is effected in a manner known per se by way of a Sobel operator, thus a simple edge-detection filter which determines this.

The evaluation of a characteristic of a particle is basically effected in the focused image, unless the characteristic indeed is directed to a property between the focused and non-focused image. The evaluation however, as trials have found, becomes significantly more stable if not only the image 12 in focus, but in each case also an image out of focus in the pre-focus region 13 as well as the post-focus region 14 is evaluated, wherein the application of a neuronal network is then useful, in order to also assign these “blurred” characteristics (FIG. 6).

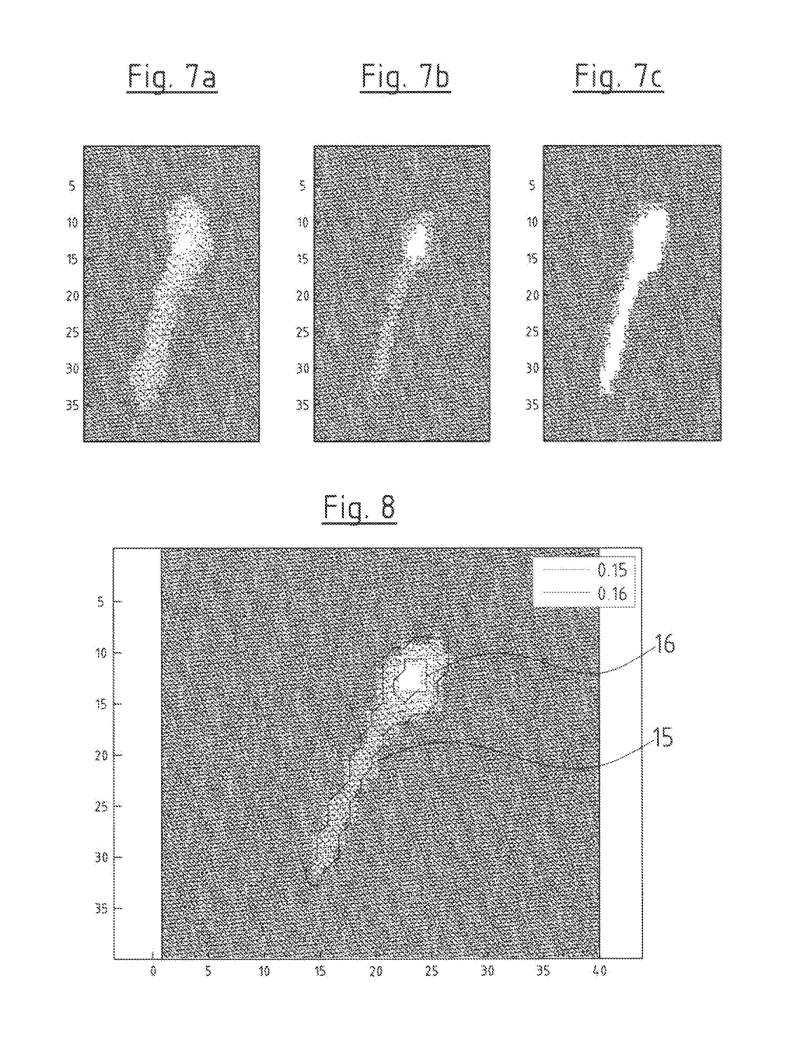

A significant characteristic of a particle is always its area in focus, and thereby the size of the area is a characteristic, and the shape of the area another characteristic. A differentiation of the particle in the image is to be fixed in order to detect these variables. This is typically effected by way of fixing a limit value, thus a grey scale of the image which corresponds to a certain pixel value. A pure black-and-white image is produced by way of this limit value, i.e. all pixels whose pixel values are the same or smaller than this limit value are represented in black and all others in white. As to how a change of this limit value affects the image is represented by way of the FIGS. 7a, 7b and 7c. Only the white areas are to be considered in the images according to FIG. 7, and the grey, shadowy areas here only serve for the illustration of the different limit values and would normally be black. The grey shadowy areas show the actual shape of the particle. It is clearly visible in FIG. 7a that the limit value which there has been set at 47% of the maximal pixel value is comparatively high since a large part of the particle falls into the black region and here presumably essential characteristics which are a characteristic of the area are lost. The limit value is set to 30% in FIG. 7b. A significantly different shape of the particle already results here in comparison to the representation according to FIG. 7a. The image according to FIG. 7c, in which the significantly elongate shape of the particles becomes visible and which is simultaneously a significant characteristic of this particle results however if the limit value is reduced to 20%. The method according to the invention now envisages varying the limit value and determining as to whether, in particular the shape of the particle significantly changes at different limit values, in order to then use the limit value which supports this pronounced shape.

The area of the particle in the image is determined by a hyperbolic curve which is applied in sections around the white area and which defines the area as is shown in FIG. 8, after the black-and-white image has been produced by way of variance of the limit value, said black-and-white image serving as the basis for the further evaluation. The enclosed area, thus the two-dimensional size of the particle can be determined by way of integrating this curve. The respective curve is characterized at 15. For comparison, a curve 16 which results when the image according to FIG. 7b is used as a basis is shown in FIG. 8. It is clear that indeed the variance of the limit value leads to the creation of a characteristic feature with regard to the shape.

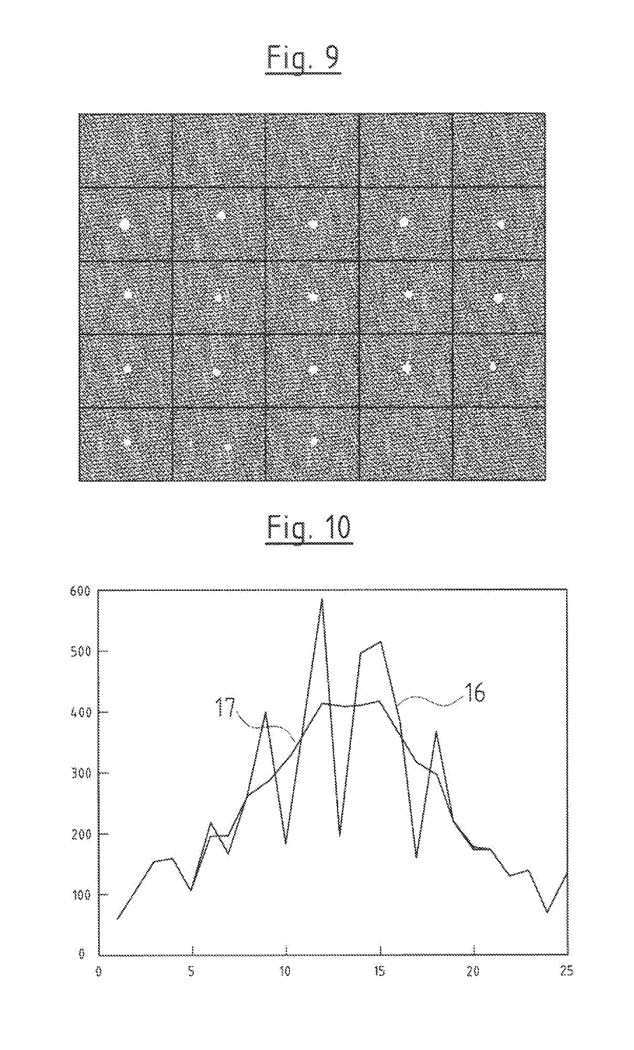

When considering an image stack, it is often to be observed that the area and shape of the detected particle changes within and outside of the focus, as is visible with the images according to FIGS. 5 and 6. Whereas with FIG. 5 it is essentially the position which changes and the other changes are rather due to focus, with the particle detected by way of the images in FIG. 6 it is evidently also the shape. This change is caused by a movement of the particle, i.e. a movement of the particle from one image to the next. If a particle which is not spherical rotates, then the light is influenced depending on how quickly and about which axis it rotates. This is perceived as a flashing with observation by eye. This is a characteristic which is often to be observed with living bacteria, but not with dead bacteria or rarely with particles which are not bacteria. This feature is an important characteristic for determining as to whether it is the case of a bacterium or another particle. In order to determine this characteristic, a stack of images, as is represented for example in FIG. 9, is firstly used for evaluation. The present 25 images which show the particle which is to be determined here, in and out of focus, are evaluated as follows:

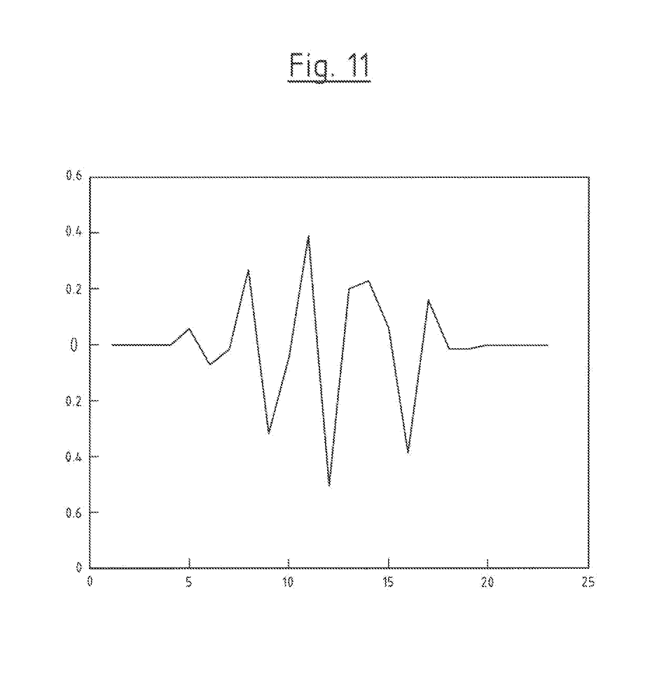

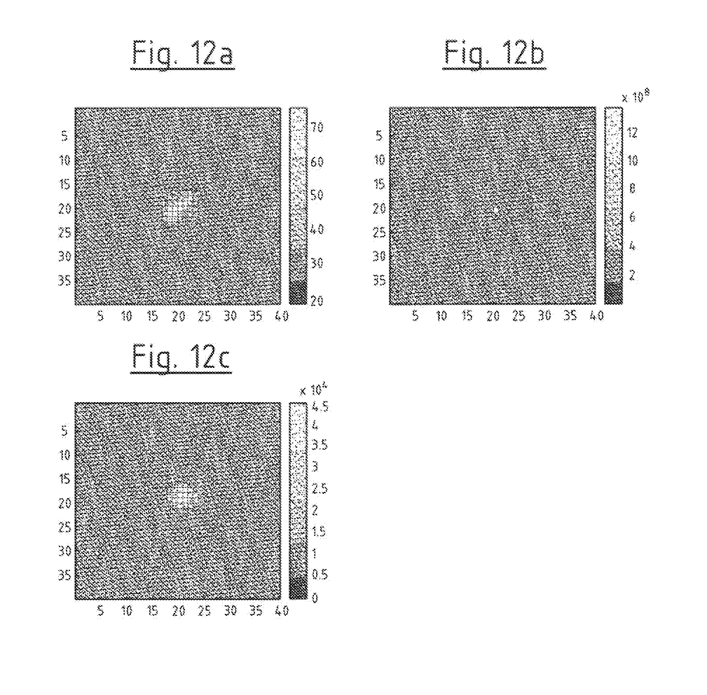

A focus curve is firstly created after the particle to be determined and the images which are considered for this have been selected, as is represented in FIG. 9. The number of images are given by the horizontal axis and the brightness of the four to seven brightest pixels determined in each image, i.e. the pixels which have the greatest pixel value are given by the vertical axis, and specifically in each case forming the mean of these four to seven pixels, so that the curve 16 evident from FIG. 10 results and this has clearly visible peaks. This curve 16 is filtered and smoothed. This smoothed curve is characterized at 17 in FIG. 10. Finally, the mean and the standard deviation are determined for the curve 17. This standard deviation is a characteristic for the detected particle. The greater this value, the larger is this “flash-effect” of the detected particle, which indicates a movement of the particle, in particular a rotation about its axis. These curves 16 and 17 are subtracted from one another in FIG. 10, so that the curve represented in FIG. 11 results, which represents the mean and the deviations from this.

A further characteristic for determining or classifying particles is the moment formation, which with image processing, in particular evaluation and classification, is counted as belonging to the state of the art. This is regularly effected by way of black-and-white images, preferably after their digitalization into black and white values, as has been described already beforehand.

A further characteristics is the moment of inertia (also called inverse moment) of a particle, thus also a characteristic which detects the spatial extension of the particle. The starting point of this characteristic for example are seven images, of which one is in focus and three are arranged on each side of the focus, as is given in FIG. 6 by the middle image 12, as well as a pre-focus image 13 and the two images lying between the images 12 and 13 as well as a post-focus image 14 and the two images lying between the focus image and the post-focus image.

A Fourier transformation is carried out on each of these seven images, of which one is represented by way of example in FIG. 12a, so that an image as is represented in FIG. 12b results. The Fourier transformation in each case results in the particle imaged in the respective image, in reciprocal space (analogously to the reciprocal lattice of crystallography). The direct current components (DC components) are then removed or at least reduced, so that an image as is represented in FIG. 12c results. The noise is also eliminated by way of a suitable filter, whereupon the central moment of each of the objects of the seven images is computed. Such a curve of an image is represented in FIG. 13, wherein the horizontal axis represents the frequency and the vertical axis the amplitude. The DC component or share with the diagram represented in FIG. 13 is already removed, and the noise components 19 are still present there. The maximal and minimal value of this central moment in each case forms a characteristic of the examined particle. The above-described characteristics as a rule are sufficient, in order to determine whether, with regard to the examined particle, it is a case of bacteria or non bacteria.

A further variance of characteristic can be achieved by way of the rows of images in different planes of the same fluid sample being evaluated with the illumination from different illumination angles and/or with illumination with light of a different wavelength. As to which characteristics are particularly suitable for which particles, in particular bacteria, in order to classify or even determine these necessitates empirical evaluation. The above-described characteristics however are particularly suitable, in order to differentiate bacteria from non bacteria, and specifically as a rule three or four of these characteristics are sufficient, in order to succeed in this classification with an adequately high reliability. Such a classification however is particularly significant with the examination of drinking water, since the detailed determining which is to say a sub-classification and specifically whether the remaining parties are bacteria and not, can be effected after the classification has been effected.

While specific embodiments of the invention have been shown and described in detail to illustrate the application of the principles of the invention, it will be understood that the invention may be embodied otherwise without departing from such principles.

1. A method for determining particles, in fluid, the method comprising:
providing an imaging optical device comprising with a light source, an optical sensor with field of light-sensitive pixels;
arranging a fluid sample which is to be examined, between the light source and the sensor;
image acquisition with the imaging optical device detecting imaging characteristics of the at least one particle which is detected;
comparing the detected imaging characteristics to characteristics of a characteristics collection, for determining the detected particle;
effecting the image acquisition with darkfield technology, and
at least one of the light-sensitive pixels comprises several subpixels which are used for the image acquisition.

2. A method according to claim 1, wherein the at least one particle is detected by way of two-dimensional black-and-white images in different planes of the fluid sample.

3. A method according to claim 1, wherein the subpixels are used for increasing the resolution or the sensitivity of the sensor or for increasing both the resolution and the sensitivity of the sensor.

4. A method according to claim 1, wherein at least one pixel of the sensor comprises several subpixels, of which at least one is high gained and at least one is low gained.

5. A method according to claim 1, wherein at least three, different characteristics of a particle are used for a detection thereof.

6. A method according to claim 1, wherein the extension of a particle with regard to area in the image, in which the particle is in focus, is used as a characteristic of a particle.

7. A method according to claim 6, wherein a pixel limit value is fixed for detecting an extension of the particle with regard to area and all pixels with a pixel value that is larger or equal to a fixed pixel limit value are set to 1, and all pixels with a pixel value that is smaller than the fixed pixel limit value are set to 0, whereupon the extension of the particle with regard to area is determined.

8. A method according to claim 7, wherein the extension of the particle with regard to area is effected based on several differently fixed pixel limit values.

9. A method according to claim 1, wherein a rotation of a particle about an axis of the particle is determined as a characteristic of the particle.

10. A method according to claim 1, wherein a characteristic of a particle is effected by evaluating a series of images of the particle in different planes, with which the particle in some images lies in focus and in some images lies out of focus, wherein a number of the pixel values representing the particle is detected in a picture-wise manner and a distribution of the detected numbers over the number of images forms the characteristic.

11. A method according to claim 10, wherein a standard deviation of the detected numbers to a mean of the detected numbers forms the characteristic.

12. A method according to claim 1, wherein a shape of a particle is used as a characteristic.

13. A method according to claim 12, wherein the shape of a particle is determined by moments of the particle.

14. A method according to claim 12, wherein the shape of a particle is determined by inverse moments of the particle.

15. -A method according to claim 14, wherein an evaluation of a series of images of the particle in different planes is effected for detecting the inverse moments of the particle, wherein the particle in at least one image lies in focus, and in a number of images in front of the particle or behind the particle, wherein the pixel values of each image are subjected to a Fourier transformation, whereupon DC components are removed or at least reduced, a noise component of the signals is eliminated and a moment evaluation is then effected.

16. A method according to claim 1, wherein an illumination intensity of the light source is held constant and a closed-loop control is provided, which detects the illumination intensity by way of the sensor and actives the light source to accordingly hold the illumination intensity constant.

17. A method according to claim 1, wherein the detection of a particle is effected by way of a comparison of detected characteristics with characteristics of the characteristics collection, by way of a non-linear system comprising a neuronal network.

18. A method according claim 1, wherein the detection of a particle is effected by way of a comparison of detected characteristics with characteristics of the characteristics collection by way of a liner system.

19. A method according to claim 1, wherein an imaging lens is arranged in front of the sensor and the imaging lens has a numeric aperture between 0.05 and 0.4.

20. A method according to claim 1, wherein images of the same fluid sample are evaluated with illumination with a different illumination angle.

21. A method according to claim 1, wherein images of the same fluid sample are evaluated one after another with illumination with light of a different wavelength.

22. A method according to claim 1, wherein a classification of the particle into bacteria, non bacteria or other particles is effected.
